(19) United States
(12) Patent Application Publication
(10) Pub. No.: US 2009/0038888 A1
(43) Pub. Date: Feb. 12, 2009

(54) Lubricant Dispenser

(76) Inventor: Egon Eisenbacher, Karlstadt (DE)

Correspondence Address: COLLARD & ROE, P.C., 1077 NORTHERN BOULEVARD, ROSLYN, NY, 11576, US

(21) Appl. No.: 12/221,016

(22) Filed: Jul. 30, 2008

(30) Foreign Application Priority Data
Aug. 8, 2007 (DE) 10 2007 037 422.6

(51) Int. Cl. F16N 11/10

(52) U.S. Cl. 184/39

(57) ABSTRACT

A lubricant dispenser has a housing that has a bottom with a housing opening, a lid, and a housing mantle between them, a lubricant reservoir, and a gas generator disposed in the housing for pressing the lubricant out. The housing mantle is transparent or translucent, at least in some sections, and has at least one barrier layer. The barrier layer has a polymer base substance and an admixture of typically inorganic layer substances to improve the barrier properties.

### CROSS REFERENCE TO RELATED APPLICATIONS

Applicant claims priority under 35 U.S.C. 119 of German Application No. 10 2007 037 422.6 filed Aug. 8, 2007.

### BACKGROUND OF THE INVENTION

1. Field of the Invention

The invention relates to a lubricant dispenser having a housing that has a bottom with a housing opening, a lid, and a housing mantle, a lubricant reservoir, and a gas generator disposed in the housing for pressing the lubricant out. The housing mantle is transparent or translucent, at least in some sections, and has at least one barrier layer. The housing mantle extends between the bottom and the lid of the housing, and usually has a cylindrical shape. The shape of the housing mantle is not restricted to the shape of a circular cylinder, but can also have any other desired footprint, for example an oval or angular shape. The bottom and/or the lid can be formed in one piece with the housing mantle, in one production step, or connected with it with a material fit. The bottom and/or the lid are disposed on the housing mantle by means of a press fit, a screw connection, or a bayonet connection.

The present invention is directed at a gas-driven lubricant dispenser in which a gas generator is disposed in a housing. A pressure is built up in a pressure chamber within the housing from the gas that is generated, which pressure typically acts on the lubricant reservoir via a piston, and presses the lubricant out of the housing opening. The further configuration of the gas generator is not restricted within the scope of the present invention, and gas is generated by electrochemical decomposition, in a galvanic process.

2. The Prior Art

A lubricant dispenser having a gas generator that has a container with an electrolyte fluid and a galvanic element formed from two metals is described in German Patent No. DE 38 11 469 C2. Electrochemical gas generation is triggered by introducing the galvanic element, and the gas generation rate can be influenced by the selection of the electrolyte fluid and the material composition and consistency of the galvanic element.

A galvanic cell for the development of hydrogen and oxygen is known from German Patent No. DE 35 32 335 C2. The galvanic cell has the form of a button battery, and the gas generation rate can be varied by changing the current flow over the gas generation element. Furthermore, gas generators are known, which have a container with electrolyte fluid and two electrodes, separated from one another, in it. The gas generation rate can be varied by changing the current flow over the electrodes and the electrolyte fluid. Such a gas generator for electrochemical generation of a gas that contains nitrogen is described in DE 10 2004 032 260 B4.

The configuration of the gas generator in which the gas generation rate can be variably controlled by a microcontroller, for example, is particularly advantageous.

In the case of the known lubricant dispensers, there is the problem that the gas generated in the lubricant dispenser diffuses out of the housing, to a certain degree, and therefore can only be partially utilized to build up pressure in the pressure chamber and for dispensing lubricant. The losses due to diffusion through the housing walls in the case of a long total lubrication duration of the lubricant dispenser, which can typically last up to a year and more, are particularly serious. In the case of diffusion, which is particularly marked when using hydrogen as the propellant gas, it must also be taken into consideration that during operation of the lubricant dispenser and emptying of the lubricant reservoir, the volume of the pressure chamber and thus the surface of the housing mantle that is relevant for diffusion constantly increase. Accordingly, the diffusion losses also increase with continuing emptying.

A lubricant dispenser having the characteristics described initially is described in European Patent No. EP 0 362 328 B1. This lubricant dispenser has a container made of a transparent plastic material. In order to reduce diffusion losses, particularly in the case of a long period of operation of up to a year, a gas-tight metal layer is applied at least in the region of the container over which a piston moves, on the outside or the inside. A narrow longitudinal region of the container wall is supposed to remain uncovered, so that the fill level can be checked. Application of the metal layer is complicated, and a user can check the fill level only if the narrow, uncovered longitudinal region remains visible in the installed state. The arrangement also requires improvement in terms of its function. If the metal layer is disposed on the inside of the container mantle, circumference-side sealing of the piston in the uneven transition region between the metal layer and the viewing window becomes difficult. If the metal layer is disposed on the outside of the container, the barrier effect is unsatisfactory, since diffusion of the gas through the plastic material cannot be effectively prevented.

A lubricant dispenser is also known from International Application Publication No. WO 2005/061947 A1, whereby the lubricant dispenser has a container having a transparent wall, which can be formed in three layers from transparent plastic. A barrier layer of polyamide (PA) or ethylene vinyl alcohol copolymer (EVOH) is provided between an inner layer and an outer layer of transparent polyethylene terephthalate (PET). The production of the at least three layers is complicated. The different layers must be selected in such a manner that the lubricant dispenser has sufficient strength, on the one hand, and high diffusion resistance, on the other hand, and it must also be possible to process the different polymer materials with one another. Finally, the barrier effect is still in need of improvement.

### SUMMARY OF THE INVENTION

It is therefore an object of the invention to provide a lubricant dispenser whose housing demonstrates good barrier properties and is easy to produce.

This object is accomplished, according to the invention, in that the barrier layer has a polymer base substance and an admixture of layer substances to improve the barrier properties. In this connection, the preferably inorganic layer substances represent a good barrier against the gas generated in the lubricant dispenser. By embedding the layer substances, the diffusion path is lengthened in the region of the barrier layer, at a predetermined thickness of the housing mantle, since the atoms of the propellant gas cannot diffuse through the layer substances, or can do so only to a limited proportion. Phyllosilicates that are preferably pretreated for being mixed into a polymer are suitable as layer substances.

The layer substances are introduced into a polymer, preferably thermoplastic base substance, and the layer substances are preferably completely exfoliated, i.e. flaked off from one another, at least to a great extent, and are present in the thermoplastic polymer or thermoplastic polymer mixture of the barrier layer as finely dispersed lamellae. It is practical if the individual lamellae have a very low thickness in a range of typically 0.5 to 1.5 nanometers (nm), particularly preferably between 0.8 and 1.2 nm. In this connection, the lamellae have a large surface expanse in comparison with their thickness. The ratio of the average diameter, measured perpendicular to the thickness, to the thickness preferably lies between 300 and 1100, particularly preferably between 200 and 500. Within the scope of the invention, montmorillonite particles that have the desired properties and preferably have an organophilic surface, as the result of a corresponding pretreatment, are suitable as layer substances.

Preferably, individual lamellae are oriented in an essentially planar manner, in accordance with the expanse of the housing mantle. Thus, for example in the case of a housing mantle in the configuration of a circular cylinder, the surface normal lines of the individual lamellae point in the direction of the longitudinal axis of the housing mantle. The orientation of the lamellae can, in particular, be achieved by means of the production process of the barrier layer, whereby the orientation results from the flow direction of the polymer base substance of the barrier layer.

It is practical if the barrier layer extends at least in the region of the housing mantle in which the pressure chamber for the gas that occurs is formed during operation of the lubricant dispenser, in the interior of the housing.

The proportion of the layer substances in the barrier layer preferably amounts to between 1 wt.-% and 10 wt.-%, preferably between 3 wt.-% and 7 wt.-%. In the case of such a proportion of layer substances, a very good barrier effect can be achieved at the usual layer thicknesses of the housing mantle, without the housing mantle losing its transparent or at least translucent properties. At a very high layer substance proportion, the production costs are increased and the mechanical properties of the barrier layer are clearly worsened.

The entire housing mantle can be formed from the barrier layer. In the case of such an embodiment, the layer substances are distributed in the entire material of the housing mantle. In order to allow the lowest possible production costs, the housing mantle can also be formed, in general, together with the bottom or the lid, as a kind of beaker. This beaker is then closed off by the lid or the bottom, respectively, after the lubricant dispenser has been filled; the lid or bottom can be disposed on the housing mantle by means of a welded, clamped, screwed, or bayonet connection. The housing mantle and the bottom or the lid can be produced, for example, by means of a multi-component injection-molding method, and only the housing mantle of the injection-molded part has an admixture of layer substances for improving the barrier properties.

In one embodiment of the invention, the housing mantle is formed by a multi-component injection-molding method, and has not only the barrier layer but also a second component of a thermoplastic polymer or a thermoplastic polymer mixture. Because the barrier substances are mixed into the barrier layer, brittleness can occur, so that there is an increased fracture risk. By combining the barrier layer with a second component in a multi-component injection-molding method, both a good barrier effect by the barrier layer, in the region relevant for gas permeation, and good stability by the second component can be achieved.

The second component can consist of the base substance of the barrier layer and is free of layer substances. Within the scope of such an embodiment, an optimal compound strength between the second component and the barrier layer can be achieved, and only one polymer material or only one polymer mixture has to be kept available for production. In addition to polyolefins such as polyethylene, polypropylene, polyethylene copolymer, polypropylene copolymer, or mixtures of these polymers, polyethylene terephthalate (PET) and also polyamides (PA) are particularly suitable as a base substance.

In a preferred production method, the housing mantle can also have multiple layers, which can be formed from different polymers. In order to achieve a particularly good barrier effect with the multi-component injection-molding method described above, both the barrier layer and the second component have an admixture of layer substances, and the weight proportion of the layer substances in the second component is lower than in the barrier layer, so that the second component still has sufficient stability.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a lubricant dispenser according to one embodiment of the invention;

FIG. 2 shows an alternative embodiment of the lubricant dispenser according to the invention;

FIGS. 3a and 3b show alternative embodiments of a housing mantle of a lubricant dispenser in a detail view; and

FIG. 4 shows another alternative embodiment of the lubricant dispenser according to the invention.

### DETAILED DESCRIPTION OF THE PREFERRED EMBODIMENT

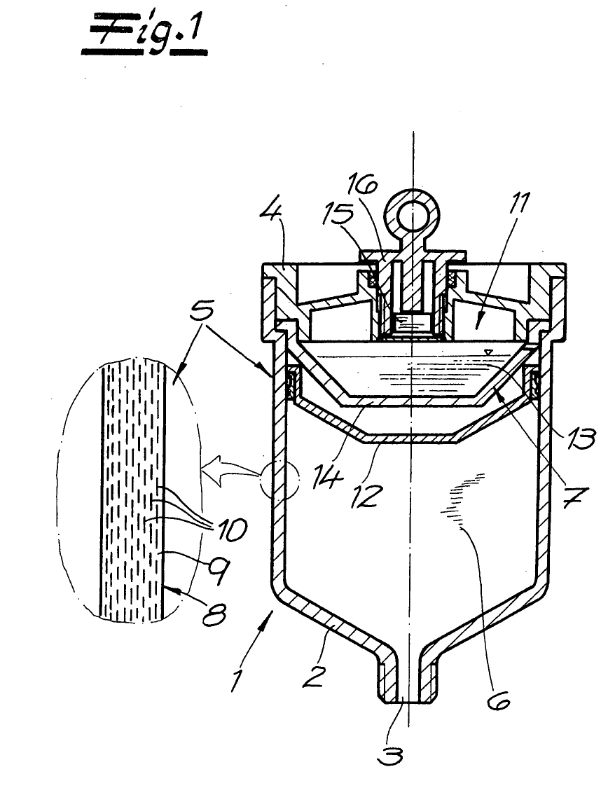

Referring now in detail to the drawings, the general structure of a lubricant dispenser according to the invention can be seen in FIGS. 1, 2, and 4. A housing 1 of the lubricant dispenser has a bottom 2 having a housing opening 3, a lid 4, and a cylindrical, preferably a circular cylindrical housing mantle 5 between them. A lubricant reservoir 6 that follows the housing opening 3 and a gas generator 7 for pressing the lubricant out through housing opening 3 are situated in housing 1. In the lubricant dispensers shown, housing mantle 5 is transparent or at least translucent, and has a barrier layer 8, at least in some sections, which has a polymer base substance 9 and an admixture of layer substances 10 to improve the barrier properties. A pressure chamber 11 for the gas formed by gas generator 7 is separated from lubricant reservoir 6 by a piston 12. Piston 12 is moved by the built-up pressure and the lubricant is pressed out through housing opening 3. The position of piston 12 and therefore the fill level of the lubricant dispenser can be seen through housing mantle 5.

With the lubricant dispenser shown in FIG. 1, bottom 2 and cylindrical housing mantle 5 are produced in one piece, together, using an injection-molding method. Housing mantle 5 and also bottom 2 are formed from barrier layer 8, which has a thermoplastic polymer or a thermoplastic polymer mixture as base substance 9. Barrier layer 8 contains phyllosilicates as layer substances 10, at a proportion of preferably about 5 wt.-%. Layer substances 10 are completely exfoliated, or at least exfoliated to a great extent, i.e. separated from one another, and finely dispersed in base substance 9. The thickness of layer substances 10, which are present as lamellae, is typically in the nanometer range, whereby the ratio of the average diameter to the thickness usually lies between 200 and 1100. The lamellae generally have an irregular contour, whereby the average diameter indicated refers to a circular area having the same area content. In the exemplary embodiment of FIG. 1, lid 4, which can, without restriction, also consist of the material of barrier layer 8, is pressed, welded, or glued into housing mantle 5. Gas generator 7 is formed from a basin 14 filled with electrolyte fluid 13 and a galvanic element 15, which is disposed in a sleeve 16 at first. To put the lubricant dispenser into operation, sleeve 16 is screwed into an opening of lid 4, and galvanic element 15 falls into electrolyte fluid 13 and triggers an electrochemical gas generation reaction.

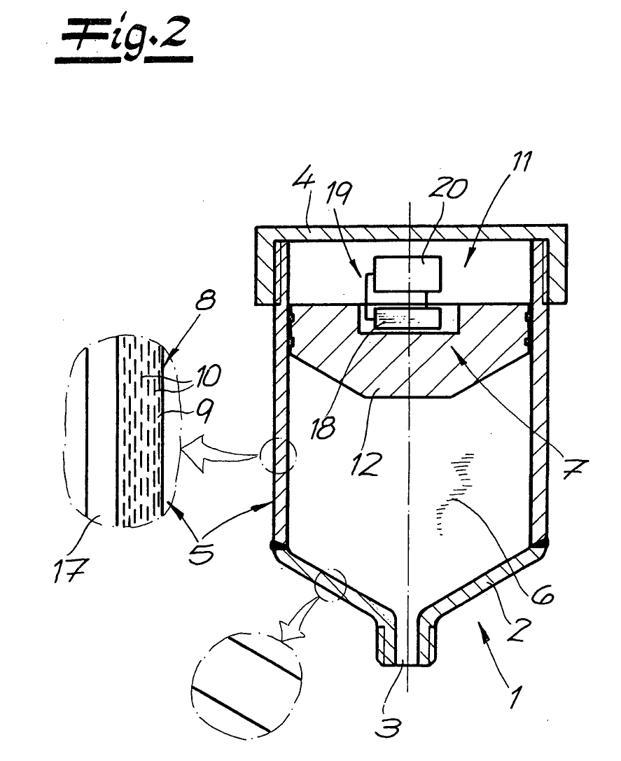

FIG. 2 shows an alternative embodiment of the lubricant dispenser, in which housing mantle 5 is formed in two layers, with a barrier layer 8 as described above, and an outer layer of a second component 17 of a thermoplastic polymer or a thermoplastic polymer mixture. While barrier layer 8 has become somewhat brittle due to the admixture of the layer substances 10, the outer layer formed from second component 17 guarantees the required stability and breakage resistance of the lubricant dispenser. The two layers of housing mantle 5 are formed in a two-component injection-molding method, and the outer layer, without restriction, can be formed from base substance 9 of the barrier layer 8 or from another polymer. Without restriction, polyolefins, PET, and PA are particularly suitable. In the case of the embodiment shown in FIG. 2, bottom 2 is welded onto housing mantle 5, or also injection-molded on using the two-component injection-molding method, or consists of only one layer that is free of layer substances 10. In the pressure chamber 11 for the gas that is formed, a galvanic cell 18 is disposed as a gas generator 7 and has the form of a button cell. Galvanic cell 18 is connected with an electrical circuit 19 having a microcontroller 20, whereby control of the gas generation rate, as needed, is possible by microcontroller 20, by varying the current that flows over galvanic cell 18.

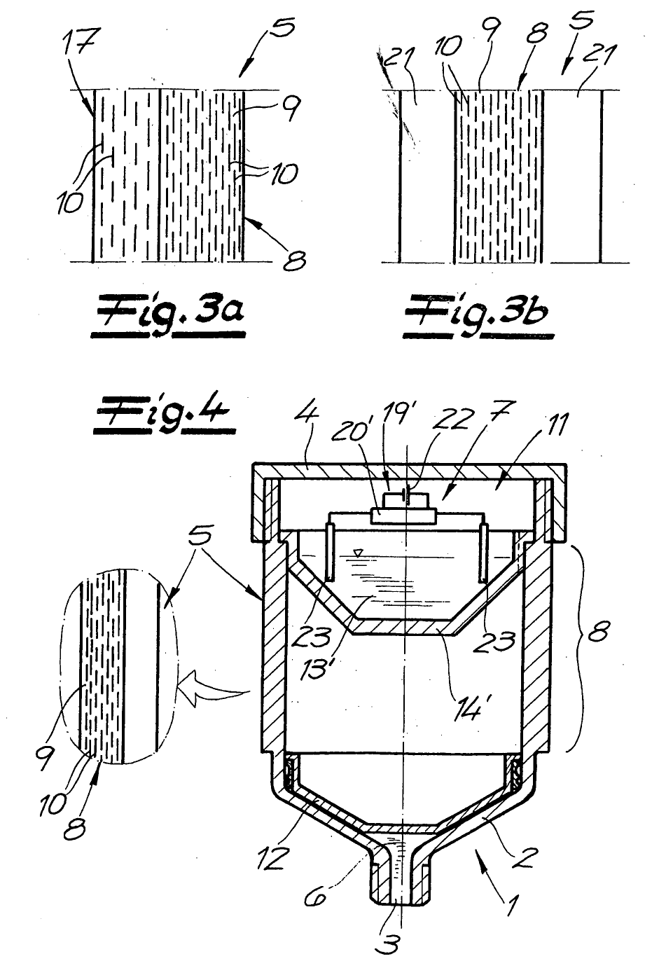

FIG. 3a and 3b show alternative embodiments of the housing mantle 5 with a two-layer and three-layer structure, respectively. According to the exemplary embodiment of FIG. 3a, housing mantle 5 is formed from barrier layer 8 and another layer of a second component 17. Second component 17 has a low proportion of layer substances 10. The barrier properties can be improved by means of layer substances 10 in the second component 17 so that housing 1 still has sufficient mechanical stability. FIG. 3b shows a three-layer structure in which barrier layer 8 is disposed between two other layers 21.

FIG. 4 shows an alternative embodiment of the lubricant dispenser, in which barrier layer 8 is situated only in a region of housing mantle 5 over which piston 12 passes. In the exemplary embodiment shown, gas generator 7 has a basin 14′ with an electrolyte fluid 13′, into which two electrodes 23 connected to a voltage source 22 and a microcontroller 20′ by way of a circuit 19′ dip. The gas generation rate, which is typically a linear function of the current that flows over electrolyte fluid 13′, can be adjusted as needed by microcontroller 20′. Microcontroller 20′ can also be connected with an external interface for programming. As in the case of the embodiment according to FIG. 2, lid 4 is screwed onto housing mantle 5.

Accordingly, while only a few embodiments of the present invention have been shown and described, it is obvious that many changes and modifications may be made thereunto without departing from the spirit and scope of the invention.

What is claimed is:

1. A lubricant dispenser comprising:
a housing that has a bottom with a housing opening, a lid and a housing mantle;
a lubricant reservoir disposed in the housing, and a gas generator disposed in the housing for pressing the lubricant out,
wherein the housing mantle is transparent or translucent, at least in some sections, and has at least one barrier layer having a polymer base substance and an admixture of layer substances to improve barrier properties.

2. The lubricant dispenser according to claim 1, wherein a proportion of the layer substances in the barrier layer amounts to between 1 wt.-% and 10 wt.-%.

3. The lubricant dispenser according to claim 1, wherein a base substance of the barrier layer is a thermoplastic polymer or a thermoplastic polymer mixture, and wherein the layer substances consist of an inorganic material.

4. The lubricant dispenser according to claim 1, wherein the layer substances are present in the base substance as finely dispersed lamellae.

5. The lubricant dispenser according to claim 4, wherein the lamellae are oriented in a planar manner, parallel with an expanse of the housing mantle.

6. The lubricant dispenser according to claim 1, wherein at least some portions of the housing mantle are configured in multiple layers.

7. The lubricant dispenser according to claim 1, wherein the housing mantle and the bottom or the lid are formed by a multi-component injection-molding method, and at least the mantle of the injection-molded components has an admixture of layer substances to improve the barrier properties.

8. The lubricant dispenser according to claim 1, wherein the housing mantle is formed by a multi-component injection-molding method, and, in addition to the barrier layer, has at least a second component made of a thermoplastic polymer or a thermoplastic polymer mixture.

9. The lubricant dispenser according to claim 8, wherein the second component consists of a base substance of the barrier layer.

10. The lubricant dispenser according to claim 8, wherein the second component has an admixture of layer substances and wherein a weight proportion of the layer substances in the second component is less than in the barrier layer.
